(19) United States
(12) Patent Application Publication
(10) Pub. No.: US 2022/0194694 A1
(43) Pub. Date: Jun. 23, 2022

(54) METHOD AND APPARATUS FOR TWISTLOCK HANDLING AND MANAGEMENT

(71) Applicant: RAM SMAG LIFTING TECHNOLOGIES PTE LTD, Singapore (SG)

(72) Inventors: Cameron HAY, Singapore (SG); Manivannan S/O CHELLAPPA, Singapore (SG)

(73) Assignee: RAM SMAG LIFTING TECHNOLOGIES PTE LTD, Singapore (SG)

(21) Appl. No.: 17/599,438

(22) PCT Filed: Mar. 27, 2020
(86) PCT No.: PCT/SG2020/050180

§ 371 Date: Sep. 28, 2021

(30) Foreign Application Priority Data
Mar. 29, 2019 (SG) 10201902869R

(51) Int. Cl. B65D 90/00

(52) U.S. Cl. CPC B65D 90/002; B65D 2590/0033

(57) ABSTRACT

A system for coupling and decoupling of a twistlock to and from a container, the system comprising: an actuated linkage having a master effector at an end of said linkage; an array of end effectors, each end effector corresponding to a different type of twistlock; said actuated linkage arranged to move the master effector between a pre-determined end effector within said array, a twistlock storage area and a casting of said container, said casting arranged to receive the twistlock; wherein the master effector is arranged to engage the predetermined end effector and either de-couple a twistlock from the casting before moving the twistlock to the twistlock storage area or engaging a twistlock within the twistlock storage area and moving said twistlock to the casting for coupling to the container.

### FIELD OF THE INVENTION

The invention relates to intermodal devices such as containers used for the transport of goods. In particular, the invention relates to the means of connecting said containers such as twistlocks. Specifically the invention relates to the means by which said twistlocks are coupled and decoupled, and subsequent management of said twistlock devices.

### BACKGROUND

Twistlocks require rotational effort with human hands to attach or detach one from a corner casting. Many models also require concurrent activation of levers or catches to free them from the corner castings. For container vessels, stevedores install semi-automatic deck twistlocks, semi-automatic hatch twistlocks, automatic midlocks or fully automatic deck twistlocks at the corner castings while the quay crane holds containers over the wharf floor prior to loading onto the vessel. Twistlocks are also removed in the same way from boxes after discharge from the vessel. Most quay cranes use twin-lift spreaders that lift two 20′ boxes in tandem giving stevedores the maximum workload of eight twistlock points in a cycle. Two stevedores take up to ninety seconds to complete their job for a twin-lift cycle in crane operations upon a container vessel.

Unlike working on ground level for vessel operations, for container movement by railcars stevedores fix manual twistlocks to the top corner castings of the lower box before putting another box on top. Further unlike vessel operations using the range of semi-automatic and automatic twistlocks, stevedores need to carry out an additional step to lock manual twistlocks once the top container is stacked onto the bottom container. The application of this invention in railcar containers will be further explained in ‘preferred embodiments’ section.

A quay crane scores up to thirty cycles in an hour largely due to stevedores' accurate handling of twistlocks. Most boxes on deck use four deck-type twistlocks. 20′ boxes in the hatch use two hatch-type twistlocks while 40′ boxes in the hatch load without twistlocks. Many vessels also require automatic midlocks which are used in combination with semi-automatic deck twistlocks on some 20′ boxes. Twistlocks generally weigh between 3 to 6 kilograms, and are repeatedly moved to updated stowage plans, or, when cranes alternate between adjacent vessels to maximize productivity.

Removing hundreds of twistlocks, moving them about and selectively fitting on outgoing boxes is gruelling work. However, ports have not automated the task mainly because there is a vast diversity in twistlock use amongst vessels in service—a range of about fifty models are in circulation. The present invention will enable cranes to automate operations over the entire range, including alternated operations involving various twistlock types and combined use of semi-automatic deck twistlocks and midlocks on 20′ boxes within a cycle.

### SUMMARY OF INVENTION

In a first aspect, the invention provides a system for coupling and decoupling of a twistlock to and from a container, the system comprising: an actuated linkage having a master effector at an end of said linkage; an array of end effectors, each end effector corresponding to a different type of twistlock; said actuated linkage arranged to move the master effector between a pre-determined end effector within said array, a twistlock storage area and a casting of said container, said casting arranged to receive the twistlock; wherein the master effector is arranged to engage the predetermined end effector and either de-couple a twistlock from the casting before moving the twistlock to the twistlock storage area or engaging a twistlock within the twistlock storage area and moving said twistlock to the casting for coupling to the container.

In a second aspect, the invention provides a method for coupling and decoupling a twistlock to and from a container, the method comprising the steps of: moving a master effector, located at the end of an actuated linkage, to an array of end effectors, each end effector corresponding to a different type of twistlock an actuated linkage having a at an end of said linkage; fixing a predetermined end effector to the master effector, from the array of end effectors; either;

moving the end effector to a casting of the container and engaging a twistlock coupled thereto, and de-coupling the twistlock using the end effector, then; moving the de-coupled twistlock to a twistlock storage area and disengaging said twistlock to said twistlock storage area; or;
moving the end effector to a twistlock storage area and engaging a twistlock coupled thereto, and de-coupling the twistlock using the end effector, then; moving the twistlock to a casting of the container and coupling the twistlock to the casting, then; disengaging said twistlock from the end effector.

Accordingly, having an actuated linkage, such as a robot arm, that includes a master effector arranged to engage a variety of end effecters, with each end effector arranged to engage a particular type of twistlock device, the system allows for use in a wide range of conditions. It may further provide access to a end effector or tool storage rack, for selection of the appropriate end effector.

In a further embodiment, having the robot arm able to translate relative to a container provides a further degree of freedom so as to travel longitudinally along the work cell. In so doing, the invention may provide the ability to access each of the critical twistlock coupling points.

### BRIEF DESCRIPTION OF DRAWINGS

It will be convenient to further describe the present invention with respect to the accompanying drawings that illustrate possible arrangements of the invention. Other arrangements of the invention are possible and consequently, the particularity of the accompanying drawings is not to be understood as superseding the generality of the preceding description of the invention.

FIG. 1 is an exploded isometric view of the system according to one embodiment of the present invention;

FIG. 2 is a detailed view of a work cell according to a further embodiment of the present invention;

FIG. 3 is a isometric view of the system according to a further embodiment of the present invention;

FIG. 4 is a detailed view of an end effector rack according to one embodiment of the present invention.

FIG. 5 are various views of twistlock devices according to the prior art;

FIGS. 6A and 6B are various views of a work cell according to a further embodiment of the present invention;

FIGS. 7A to 7C are parts of a Category 1 setup according to a further embodiment of the present invention;

FIG. 8A to 8C are parts of a Category 2 setup vertically exploded according to a further embodiment of the present invention;

FIGS. 9A and 9B are, respectively, a Category 1 twistlock and a Category 1 end effector according to a further embodiment of the present invention;

FIG. 10 is an isometric view of a Category 2 end effector in proximity to a Category 2 twistlock according to the present invention;

FIGS. 11A and 11B are various views of a master effector according to one embodiment of the present invention; and

FIGS. 12A to 12C are various views of the system according to further embodiments of the present invention.

### DETAILED DESCRIPTION

The invention seeks to solve the problem of manually handling twistlock devices which is inherently labour intensive, hazardous and time consuming. The invention provides for a work cell having at least one actuated linkage, such as a robot arm, that is selectively able to select from a range of end effectors, each arranged to engage a particular type of twistlock.

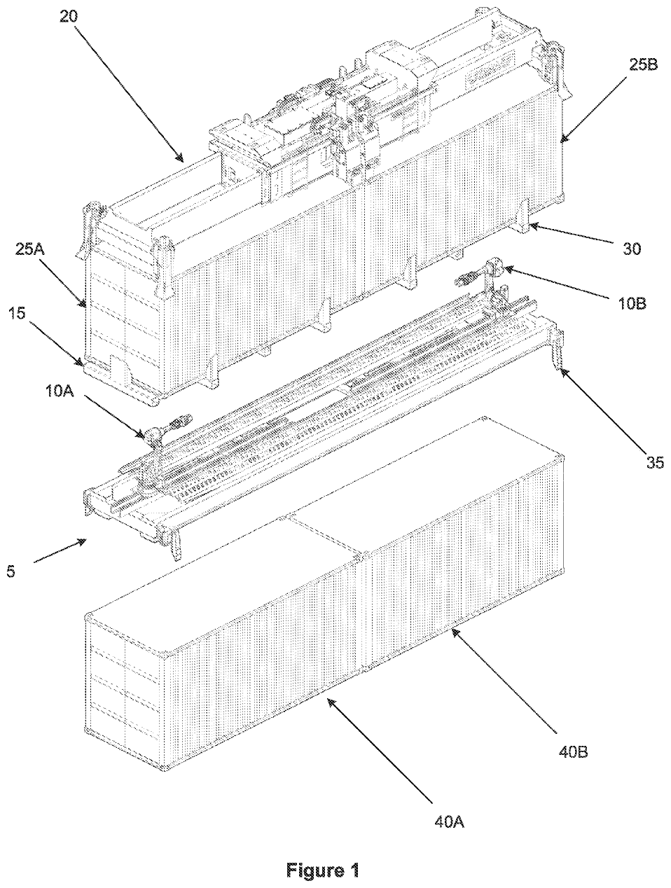

FIG. 1 shows an embodiment of the present invention having a work cell 5 with, in this case, a pair of actuated linkages, being robot arms 10A, 10B. The actuated linkages may be a plurality of members connected through joints. Said joints may be driven, and provide at least 1 and up to 6 rotational degrees of freedom about 6 principal axes. The linkage as a whole may therefore have a wide range of movement based upon the rotation at each joint. The work cell may be lifted into place through connection to a crane, headblock or forklift. To this end it may include lifting components corresponding to any or all of these apparatus

In this particular embodiment the work cell 5 is arranged to manage twistlocks for connecting two lower 20 foot containers 40A, 40B to two upper 20 foot containers 25A, 25B.

The upper containers 25A, 25B are engaged by a twin headblock 20 which lowers the containers onto a crane platform 15 which is arranged to accurately locate the containers 25A, 25B through location blocks 30.

The robot arms 10A, 10B having access to the underside of the containers 25A, 25B can place twistlocks at the corner castings of the containers. Importantly for this embodiment, as there are two containers to be managed, in addition to the end castings there are also four castings at the point upon which the containers 25A, 25B interface. As the robot arms 10A, 10B are free to travel along the work cell 5, twistlocks can be coupled to the containers 25A, 25B at all eight castings by the single work cell 5.

In some cases, prior art devices rely on a conveyor chain or magazines for transporting twistlocks to and from the twistlock installation points of the containers. A substantial limitation with these methods is, a chain of consecutive feed to the robots cause an entire line of twistlocks to be jammed if even one twistlock causes a mechanical problem.

Up to 200 twistlocks may be processed each hour for a crane functioning at normal productivity of 25 twin-lift cycles an hour. A 40′ bay may contain 300-400 containers and require periodic replenishment of twistlocks or storage capacity, respectively for loading and discharge operations. There is no provision in the prior art for a systematic replenishment method of storage capacity.

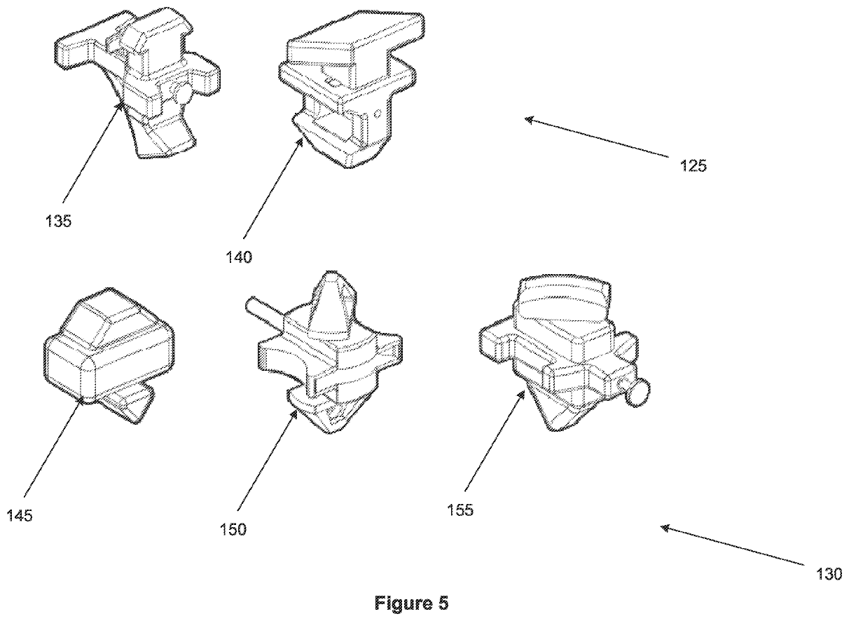

In one embodiment, disclosed storage frames may include a variety of twistlock types in numbers for free form selection, enabling the handling of various twistlock types needed in quick succession during container operations. To illustrate using the loading cycle, a robot arm according to the present invention, having access to a few different end effectors may alternately select different twistlocks from the storage frame just as, a multitude of robots each with a different end effector can simultaneously pick different twistlocks from the storage frame. Thus, storage frames may allow free selection of a variety of twistlocks from the pool for transfer to any installation point under the container/s without disturbance to other twistlocks in storage, and vice versa for discharge cycles. These advantages are discussed with reference to the various embodiments of FIGS. 2 to 5.

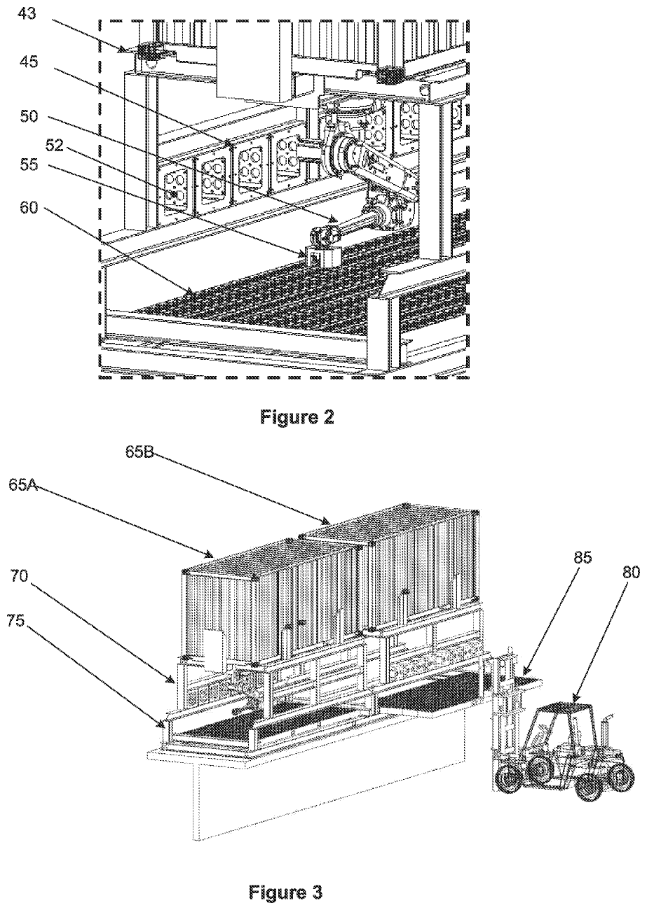

FIGS. 2 and 3 show a different embodiment of the present invention having a work cell mounted to a frame 70 upon which the containers 65A and 65B are positioned. The frame in this case is placed on a crane platform, with twistlock storage racks 85 being placed into, and taken from, the work cell 75 by a forklift 80.

The twistlocks 60 are taken from the racks 85 by the robot arm 50 for placement onto the castings of the containers 65A, 65B. It will be appreciated that the reverse is also true that the robot arm 50 can decouple the twistlocks for placement into the storage frame. Accordingly, FIG. 3 may indicate the forklift 80 removing the storage rack 85 from the work cell 75.

FIG. 2 shows a further embodiment of the present invention whereby the robot arm 50 includes an end effector 55 arranged to engage the twistlock 60. The end effector 55 is suited for the type of twistlock 60 so as to not only engage and disengage the twistlock but also to activate the twistlock when coupling to the castings 43 of the container.

A further embodiment, shown in FIG. 2, is an array of end effectors, or tool rack 45. It will be appreciated that there are several different types of twistlocks used for containers. Whilst the various twistlocks can be placed and removed from a twistlock storage area, such as through the selectively removable storage rack 85, to have the work cell 75 usable in a range of different applications in this embodiment the tool rack 45 includes several tool recesses 52. Placed within the tool recesses 52 are end effectors 55 arranged to lock and unlock a variety of different twistlocks. The robot arm 50 is therefore arranged to select from the plurality of tool recesses 52, the end effector that matches the twistlock 60 to be used with the containers 65A, 65B. In a further embodiment, containers 65A, 65B may be placed on the frame 70 on the crane platform and the respective twistlocks within the storage frame 85 placed so as to be accessed by the robot arm 50. The robot arm selects the appropriate end effector 55 from the respective tool recess 52 and so then commences the process of engaging a twistlock 60 for insertion into the casting 43.

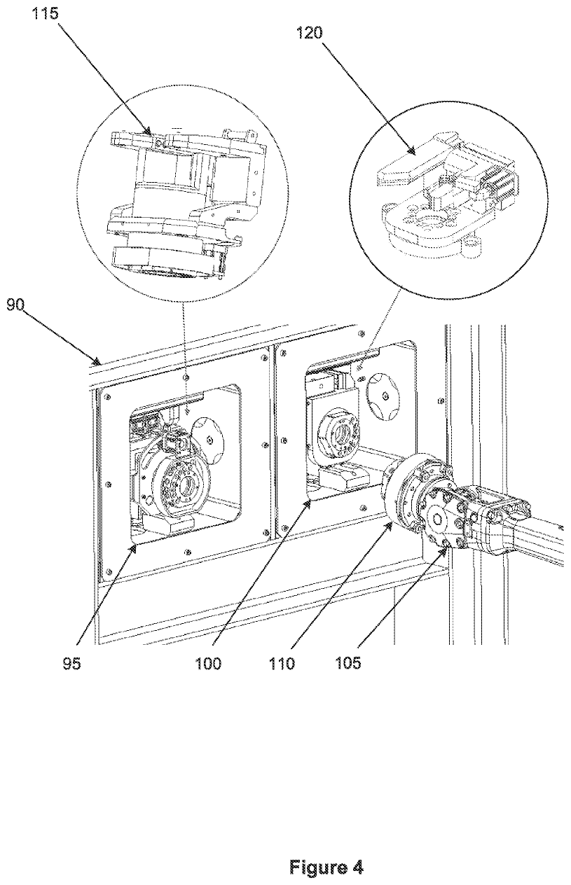

FIG. 4 shows a specific embodiment described in general terms with reference to FIGS. 2 and 3. Here, a robot arm 105 includes a master effector 110 which is arranged to select one of two end effectors 115, 120. The end effectors 115, 120 are placed within the tool rack 90 and, in particular, within respective tool recesses 95, 100. The robot arm 105 makes the selection of the type of end effector required and consequently fixes to, and withdraws, the end effector associated with the twistlock. The selection of the predetermined end effector may be input by an operator, based upon an expected type of twistlock used by the arriving vessel, or the preference of the port authority. The information may also be digitally uploaded to a control system associated with the robot arm. For instance, a vessel which maintains proper inventory uses either two or three types of twistlocks. Namely, Deck SATL+hatch cone; Deck SATL+Deck midlock+hatch cone; or Deck FAT+hatch cone. Despite such vessel correctly maintaining homogenous pool of each type it uses, operation sequences may be altered in real time, and therefore it may not be predictable if the next twistlock coming into storage or needed for loading is deck, deck with midlock or hatch (example applicable in a SATL type vessel). Variability also includes the possibility that the operation may be manually switched from loading to discharge.

The location of the various end effectors, position and type of twistlocks in the storage rack, and completed and pending action upon container castings will all be stored and accessible by the control system.

As an indication of the variety of twistlocks to be managed by the present invention, these may fall within two categories. Category 1 twistlocks 125 are single block devices such as an automatic midlock 135 or a fully automatic deck twistlock 140. The second category of twistlocks 130 are two part and include semi-automatic hatch twistlock 135, a manual twistlock for rail car containers 150 and semi-automatic deck twistlock 155.

The use of the first or second category depends on the application, however whilst many vessels tend to use semi-automatic deck twistlocks, there are also a portion of such vessels which also use the first category 1 one-piece twistlock for hatch stowage. As hatch operations frequently interrupt deck operations, prior art devices cannot sustain automation without human intervention to clear one-piece twistlocks that do not match with Category 2 semi-automatic deck twistlocks. Further, many of such vessels also use automatic mid-locks to provide back to back stowage of 20 foot containers to prevent cargo theft which entails still further human intervention.

Known end effectors include specific actuators to work the levers or catches as necessary when the end effector is in position around the twistlock. Each end effector has a tool plate for the master effector to lock into, and, an array of quick release utility ports that match with ports on the master effector for compressed air, hydraulic fluid, or electricity to flow to actuators in order to operate components of the end effector. Essentially, on engagement of the end effector with the master effector, power to the end effectors is provided, which may also include data for the remote operation of the end effector.

By providing a work cell with multiple end effectors which can be fixed to the robot arm as part of the process, a work cell according to this embodiment avoids interruption as the switch between Category 1 and Category 2 twistlocks is made. This eliminates crane downtime between cycles even when a single container includes different twistlock types. It may be a simple step within the procedure for the robot arm to unfix one end effector and fix a second end effector in order to continue the coupling/decoupling for the container.

Whilst Category 1 and Category 2 twistlock devices tend to dominate the industry, other twistlock devices exist and are in common use. For existing systems, this introduces a further degree of complication. It will be appreciated that a further embodiment of the work cell may include several tool recesses to include multiple types of end effectors such that the work cell can be used in any situation despite the type of twistlock being used. It will further be appreciated that having multiple tool recesses may also house the same end effector such that if an end effector becomes damaged during the process, it is a simple process to replace the damaged end effector with an undamaged tool with minimal delay in the process.

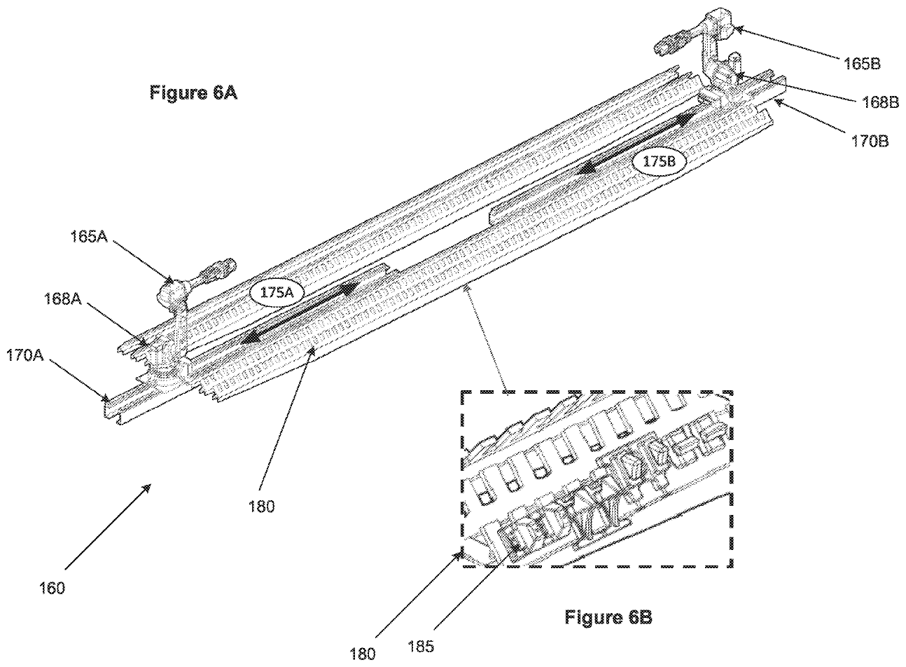

The invention may best be described by the embodiment shown in FIGS. 6A and 6B.

Here, a work cell 60 includes a pair of actuated linkages 165A, 165B positioned at opposed ends of the work cell 160. Each of the actuated linkages are movably mounted to the work cell so as to be linearly movable 175A, 175B. The movable mounting may include a linear actuator and linear guide, such as on linear slides 170A, 170B. The linear actuators may include electric or hydraulic motors 168A, 168B to drive 175A, 175B along the linear slide 170A, 170B. The work cell may therefore include a fully contained power supply. Alternatively, the work cell may be connectable to a remote power supply, such as connecting to a wharf crane or gantry crane via a spreader headblock, in order to power the work cell.

The movement of the linkages along the slide are for two primary purposes. The first is so as to access castings at a mid-point between twin containers. As mentioned, transport of 20 foot containers, end to end, require access to the castings at an interface between the containers and thus each of the actuated linkages/robot arms 165A, 165B require sufficient mobility so as to access castings for each of the 20 foot containers. Further, the work cell 165 must include sufficient space within the twistlock rack 180 so that firstly twistlocks 185 of various types are available for coupling to the containers as well as having a total number of twistlocks so as to limit the replenishing or removal of said twistlocks. Thus, the work cell 160 is an efficient system for a variety of different containers having a variety of different twistlocks and further still, for its prolonged use without intervention.

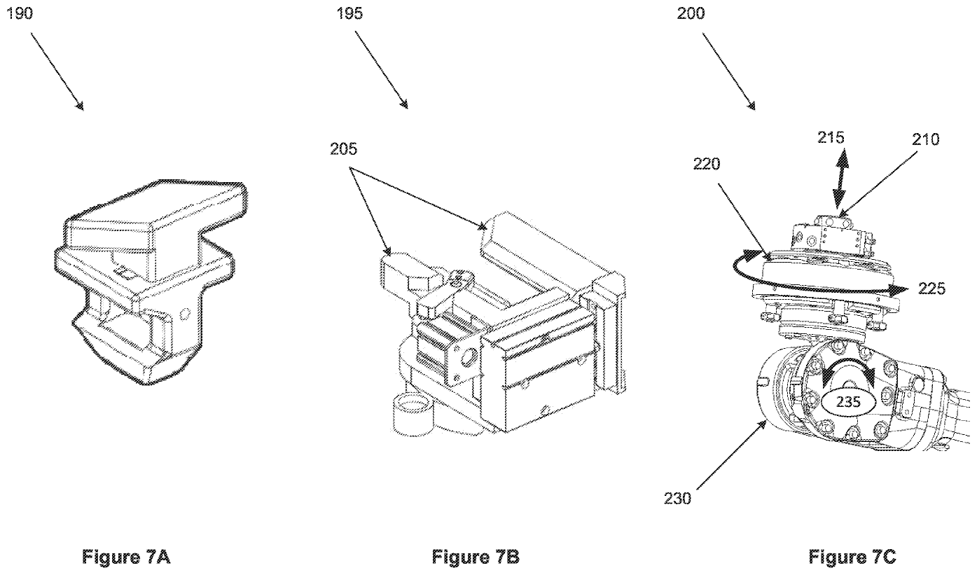

FIGS. 7A to 7C show the various portions of the Category 1 end effector assembly. The twistlock 190 is engaged by clamps 205 of the Category 1 end effector 195. The end effector 195 fixes to the master effector 200 which is located at the end of the actuator linkage or robot arm through joint 230. The joint 230 in this embodiment is rotatable 235 about a first axis with the tool master of the master effector 200 being separately rotatable 225. Connection between the master effector 200 and the end effector 195 is through the tool lock which project 215 on insertion into the end effector and rotates so as to act as a bayonet lock to lock in place. The end effector is then withdrawn from the tool recess for subsequent use.

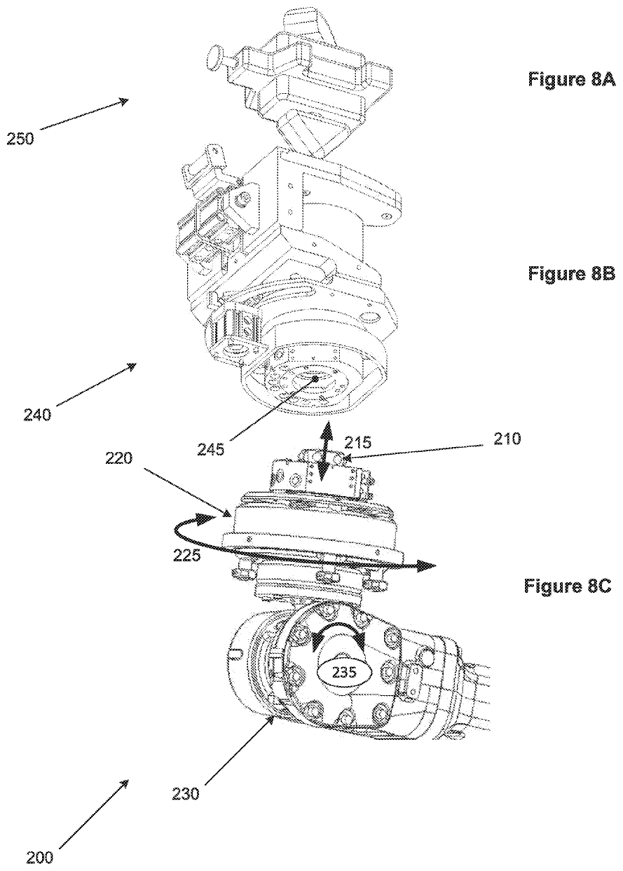

FIGS. 8A to 8C show a similar assembly for Category 2 twistlock devices 250. The Category 2 end effector 240 engages with the master effector 200 as previously described. The aperture 245 into which the tool lock 210 is inserted is identical to that of a Category 1 end effector 195. A Category 2 end effector consists of a rotating core assembly with a cup feature to surround the bottom cone of the twistlock, and a peripheral assembly with a clamp feature to grip the twistlock housing assembly. When the two parts of the end effector are locked together, rotation of robot mounting interface would affect the whole end effector, hence the whole twistlock, for transporting the twistlock just as when handling Category 1 twistlocks. With the clutch released, rotation of robot mounting interface affects only the core assembly of the end effector and hence only the cone assembly of the twistlock, if the end effector peripheral assembly or the twistlock housing assembly is held in check.

The robot arm positions the Category 2 end effector 240 around a twistlock 250 in a corner casting or storage slot in the locked state and clamps around the twistlock housing. This fixes the end effector peripheral assembly as the twistlock housing is held in place by the corner casting or the storage slot. The clutch is then released and rotates to the required degree and direction for the top cone to exit the corner casting or storage slot. Then the clutch engages to again lock the two parts of the end effector together for the robot to remove the twistlock from the corner casting or storage slot. The robot then transports the twistlock in the locked state, inserts the top cone into the corner casting or the storage slot and releases the clutch before rotating the cone to lock into the corner casting.

Prior art devices are generally directed to Category 2 twistlocks and usually use a rotary actuator to twist the bottom cone. In comparison, in one embodiment of this invention, the end effector includes a mounting interface to reduce bulky additional components while achieving controlled rotation by the same source, over the family of interchangeable end effectors. The end effector mounting interface selectively twists just the cone while holding the twistlock housing assembly constant when fixing (or removing) at the corner casting or storage frame, or, rotates the entire twistlock for transporting the Category 2 twistlock just as for Category 1 twistlocks.

In a further embodiment for Category 2 end effectors, and specifically for wire knob type semi-automatic deck twistlocks, is a wire primer to eliminate a common but serious loading error. The wire knob wraps around the spring-loaded stem connecting the top and bottom cones of the cone assembly within the housing assembly and acts as a mode selector. During discharge from the vessel the wire is set with knob pointing down, rotationally positioning the bottom cone to exit the top corner casting aperture of the bottom container. Often the wire gets stuck in the lower position, in effect keeping the twistlock in discharge mode even after it is free of the corner casting. It is of utmost importance when installing on containers during loading that the wire is primed in the middle position for wire knob type semi-automatic deck twistlocks to lock the upon containers on board.

The Category 2 end effector can take position on the various Category 2 twistlocks horizontally from front or back and from under by upward movement, to suit the situation. The inventive two-part end effector with variable clutch is effective upon all wire knob type semi-automatic deck twistlocks, manual twistlocks and automatic hatch twistlocks regardless of the extent of cone twist or direction of torque. The feature is advantageous for robot optimization as high torque and turning precision is achieved without using an additional rotary actuator.

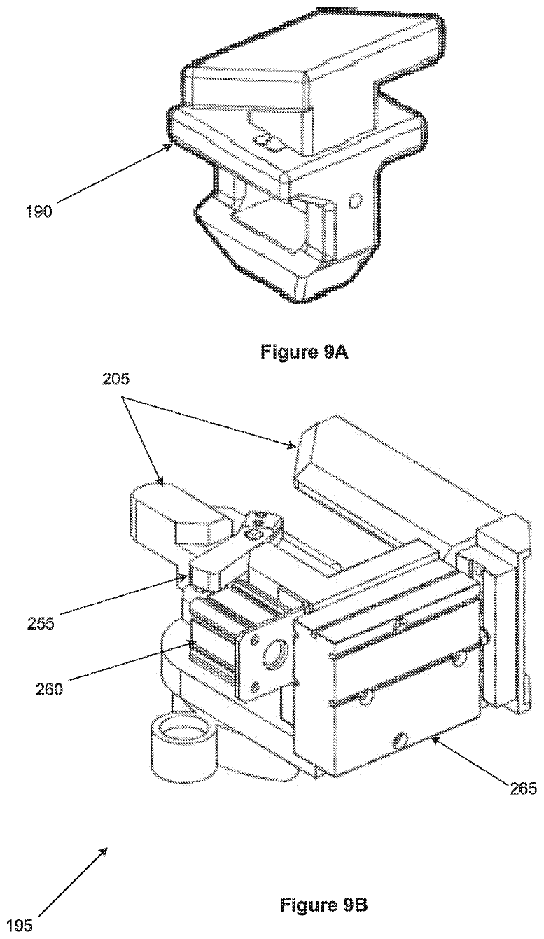

FIGS. 9A and 9B show a further view of the Category 1 twistlock 190 and Category 1 end effector 195. The clamps 205 are arranged to transversely close to engage the twistlock with the unlocking lever 255 automatically triggering the twistlock to unlock so as to either decouple from a container or be ready for insertion into a casting. The unlocking lever 255 includes an actuator 260 with the clamp 205 having an actuator 265 all contained within the Category 1 end effector.

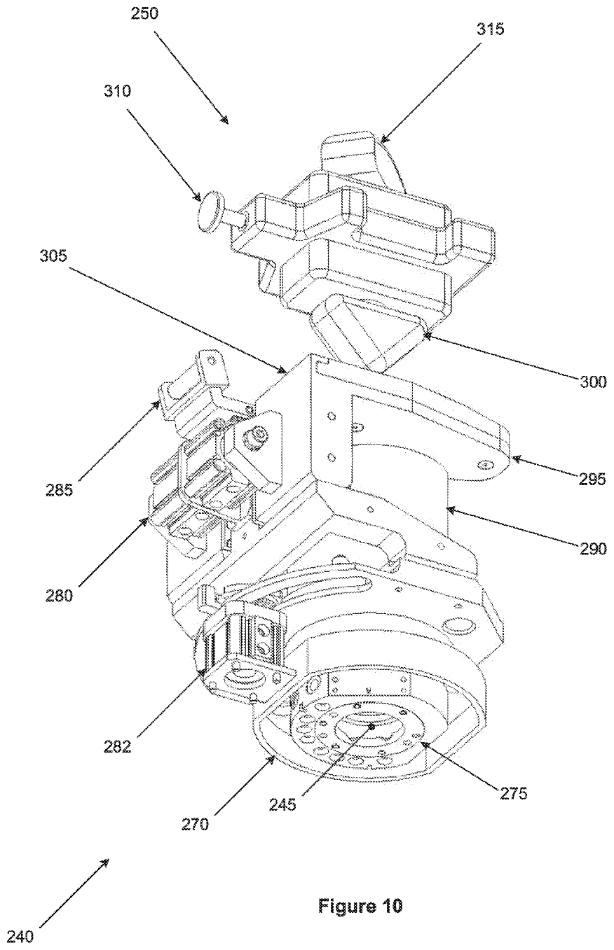

FIG. 10 shows the more complex Category 2 (2 part) twistlock 250 having a top cone 315 and a bottom cone 300 being rotatable lugs which are arranged to couple to a casting on rotation. A wire knob 310 is then used to activate or deactivate the twistlock. Accordingly, the Category 2 end effector 240 includes a wire knob primer 285, a clamp 295, a cup 290 arrangement for engaging the bottom cone 300 and clutch assembly 282. Clamp is driven by actuators 280. As previously mentioned, the aperture 245 for receiving the master effector projection, lies within a core assembly 270 having a tool plate 275.

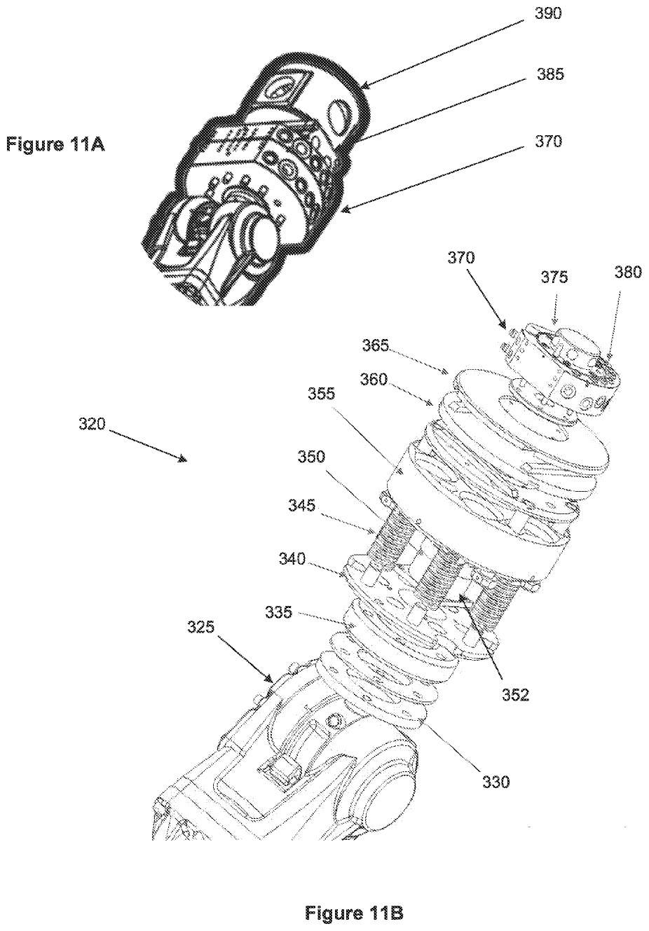

FIGS. 11A and 11B show a further embodiment of the master effector 320. In this embodiment, the master effector plays a key role ensuring proper functioning of end effectors. It may include (a) polar arrangement of dampening springs 345 that also allows for twisting and bending compliance of the end effector as it takes position around a twistlock in imperfect position; (b) horizontal centering springs 360, 365 for lateral compliance of the end effector to the twistlock, placed between the tool master and limiting block 355; (c) the tool lock 375 with a quick release catch upon the tool plates 385 of end effectors; (d) an array of quick release utility ports 380 that match with ports on the end effectors; and (e) a sensor 352, positioned adjacent to the central stiffening spring 350, for emergency end effector release to protect the robot from being torn off by the crane lifting the container if a system malfunction causes an end effector to remain locked with a twistlock lodged in a corner casting. The tool master 370 further includes a mounting plate 340 positioned over a space of 335 as it connects to the joint 325 of the robot arm through a tool mounting interface 330.

A major issue foreseen in automating in the container handling environment is the difficulty in achieving fast and reliable positioning of end effectors. Twistlocks vary in terms of fit into the corner casting aperture from loose to tight fit models. Repeated impact from high loads also cause twistlocks to deform. Damaged corner castings can also be off position relative to the overall box. Containers landed onto the platform for twistlock operations is also likely to be off position.

Devices in the prior art rely on optical sensing to index the manipulation device upon the target. This incurs great time loss and cause the devices to be less than robust.

In comparison, the master effector makes use of mechanical energy to loosen and instantly wrap end effectors around target twistlocks. The master effector also enables tolerance for misalignment when positioning end effectors upon twistlocks in storage frame slots. The dampening springs in the master effector also immunize the robot from damage due to impact shocks when end effectors contact the target.

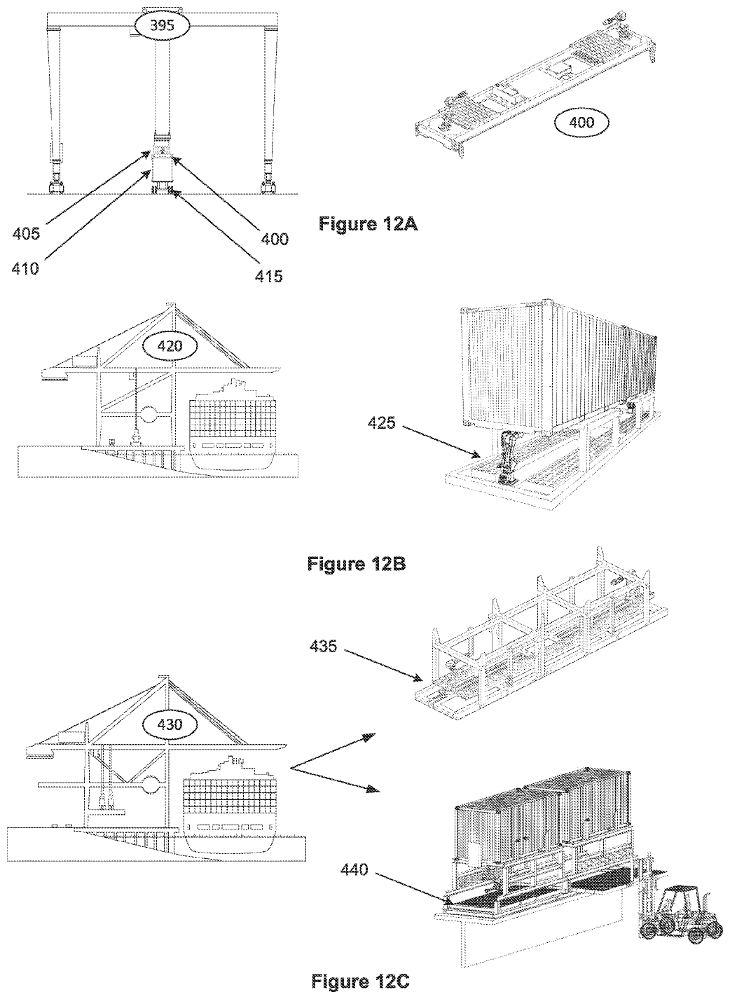

FIGS. 12A to 12C show various embodiments of the present invention. 12A shows the use of a work cell 400 with a gantry crane 395. Here a spreader 405 includes the work cell 400 so as to engage or disengage a container 410 from a rail car. In railcar loading, stevedores fix manual twistlocks to the top corner castings of the lower box before putting another box on top. Stevedores then lock the manual twistlocks while standing at floor level. The relevant embodiment of the automated twistlock work cell is a rectangular 40′ long rig to descend upon the bottom containers' top corner castings. The corner receptacles of the rig align with respective twistlock points of the container/s. The rig is equipped with two robots, four end effectors and two storage frames. A mobile lifting machine such as a rubber tyre gantry (RTG) straddles containers on the railcar while suspending the rig. The RTG moves to position the rig above the container like a lifting spreader.

Robots, end effectors, tool racks, storage frames and other components are mounted to the top of the rig which is connected to the RTG with a head-block. The robots transport the end effector, with or without twistlocks, between twistlock points on the storage frames and twistlock points of the container.

Before the rig descends on the container/s in discharging cycles, the two robots position and lock the end effectors to the corner receptacles that align with respective twistlock points of the container/s before disengaging to standby for the RTG to position the rig on the container/s. Upon landing the rig on the containers, the twistlocks lodge into the respective end effectors. Each robot then locks into its respective end effectors in turn to rotate the top cone of twistlock which simultaneously disengages the manual twistlock from the top corner casting of the target container and engages the twistlock with the end effector. The robot then disengages the end effectors from the corner receptacles of the rig to transport twistlocks to the storage frame.

For the installation process, the robot use the end effectors to pick up twistlocks from the storage frame, transport to the respective corner receptacles of the rig and lock the end effectors to the receptacles with twistlocks ready to lodge into the top corner castings of the target container when the rig is placed on the bottom container/s. Upon positioning the rig, the robots engage with the end effectors to rotate and lock the manual twistlock to the end effector which simultaneously unlocks from the top corner castings. The robots then disengage the end effectors bearing the manual twistlocks from the corner receptacles of the rig to transport the twistlocks to the storage frame.

Railroad operations contend with much less twistlock variety and also a far smaller number of twistlock are handled, compared with vessel operations. It is likely that a lone RTG operates upon a row of containers on railcars. With little need or opportunity to transfer storage frames, storage capacity can simply be permanently attached to the main frame.

FIG. 12B shows the mobile deployment on the wharf under a quay crane 420. The work cell 425 in this case is positioned beneath the container and separated by a crane platform so as to allow access to the underside of the container for the work cell. The entire system is rested on the wharf on skates and attached to the crane, enabling the system to be aligned with the crane as it moves from bay to bay along the length of the container vessel.

FIG. 12C show the quay crane 430 having a crane platform underneath which is the work cell 435 such that a spreader delivers the container to the crane platform.

Stevedores install twistlocks to the bottom corner castings of the higher box during the hoisting procedure. The box is then hoisted with the twistlocks projecting out from its bottom corner castings and placed atop the box already on board causing the twistlocks to lock into the top corner castings of the lower box.

The twistlock work cell is situated on an elevated platform attached to the crane. The support structure can be modified to hold in position a removable container landing platform. The landing platform, may include lifting components such as lifting eyes that align with a spreader in the 20′ single lift form. Hoisting the landing platform allows the storage frame to be taken out and replaced. In this embodiment, there are two robots, each on the respective linear slider. Each robot handles one half of the twin lift configuration.

The alternative position is the work cell 440 again having a platform but being supplied by a forklift. A sub embodiment of the crane platform based twistlock work cell is with the robot/s mounted in inverted position on a single linear slider. The top platform can be fixed. Storage frames can be in two halves with slots for movement by forklift.

1. A system for coupling and decoupling of a twistlock to and from a container, the system comprising:
an actuated linkage having a master effector at an end of said linkage;
an array of end effectors, each end effector corresponding to a different type of twistlock;
said actuated linkage arranged to move the master effector between a pre-determined end effector within said array, a twistlock storage area and a casting of said container, said casting arranged to receive the twistlock;
wherein the master effector is arranged to engage the predetermined end effector and either de-couple a twistlock from the casting before moving the twistlock to the twistlock storage area or engaging a twistlock within the twistlock storage area and moving said twistlock to the casting for coupling to the container.

2. The system according to claim 1, wherein the actuated linkage is movably mounted so as to permit linear translation of the actuated linkage.

3. The system according to claim 2, wherein the actuated linkage is arranged to move the master effector through a combination of articulation of the linkage and the movable mounting.

4. The system according to claim 2, wherein the movable mounting includes a linear actuator the linear actuator arranged to drive the actuated linkage.

5. The system according to claim 2, wherein the movable mounting includes a linear guide, said linear guide arranged to guide the movement of the actuated linkage.

6. The system according to claim 1, wherein the array of end effectors includes an array of tool recesses, each tool recess corresponding to one end actuator.

7. The system according to claim 1, wherein the twistlock storage area includes a twistlock storage rack for holding and receiving a plurality of twistlocks.

8. The system according to claim 1, further including a work cell, said work cell comprising a platform upon which the actuated linage is mounted, said platform having lifting components such that the work cell is arranged to be lifted via said lifting components.

9. The system according to claim 1, wherein the tool, storage area includes a twistlock storage rack, said twistlock storage rack arranged to be selectively removed from the system.

10. A method for coupling and decoupling a twistlock to and from a container, the method comprising the steps of:
moving a master effector, located at the end of an actuated linkage, to an array of end effectors, each end effector corresponding to a different type of twistlock an actuated linkage having a at an end of said linkage;
fixing a predetermined end effector to the master effector, from the array of end effectors; either;
moving the end effector to a casting of the container and engaging a twistlock coupled thereto, and de-coupling the twistlock using the end effector, then;
moving the de-coupled twistlock to a twistlock storage area and disengaging said twistlock to said twistlock storage area;
or;
moving the end effector to a twistlock storage area and engaging a twistlock coupled thereto, and de-coupling the twistlock using the end effector, then;
moving the twistlock to a casting of the container and coupling the twistlock to the casting, then;
disengaging said twistlock from the end effector.

11. The method according to claim 10, wherein each moving step includes the step of linearly translating the actuated linkage along a linear guide.

12. The system according to claim 3, wherein the movable mounting includes a linear actuator the linear actuator arranged to drive the actuated linkage.

13. The system according to claim 3, wherein the movable mounting includes a linear guide, said linear guide arranged to guide the movement of the actuated linkage.
